(19) United States
(12) Patent Application Publication
(10) Pub. No.: US 2026/0072215 A1
(43) Pub. Date: Mar. 12, 2026

(54) LOW-LOSS MODE COUPLERS BASED ON BRAGG GRATINGS USING PROPAGATION CONSTANT ENGINEERING AND TRANSMISSION LINKS INCORPORATING SAME

(71) Applicant: The Board of Trustees of the Leland Stanford Junior University, Stanford, CA (US)

(72) Inventors: Oleksiy KRUTKO, Stanford, CA (US); Anirudh VIJAY, Stanford, CA (US); Joseph M. KAHN, San Carlos, CA (US); Rebecca REFAEE, Stanford, CA (US); Nika ZAHEDI, Stanford, CA (US)

(21) Appl. No.: 19/320,725

(22) Filed: Sep. 5, 2025

Related U.S. Application Data
(60) Provisional application No. 63/691,521, filed on Sep. 6, 2024.

(51) Int. Cl. G02B 6/26; G02B 6/34

(52) U.S. Cl. CPC G02B 6/262; G02B 6/34

(57) ABSTRACT

A system including a mode coupler has at least one waveguide section connected between a mode coupler input and a mode coupler output. The waveguide section supports a set of guided coupler modes and a set of cutoff coupler modes, and has a transverse refractive index profile and a longitudinal refractive index profile. The transverse refractive index profile is adjusted by free-form optimization to yield a set of desired spacings between a set of propagation constants of the sets of coupler modes such that the longitudinal refractive index profile induces desired couplings between the guided coupler modes, while inhibiting undesired couplings between the guided coupler modes and the cutoff coupler modes, and undesired couplings between the guided coupler modes.

### STATEMENT OF RELATED CASES

This specification claims priority of U.S. Pat. App. No. 63/691,521, filed on Sep. 6, 2024 and incorporated by reference herein.

### FIELD OF THE INVENTION

The invention pertains to mode-division-multiplexing in optical waveguides.

### BACKGROUND OF THE INVENTION

Mode-division multiplexing (“MDM”) in multi-mode optical waveguides, such as optical fibers (hereinafter “MMFs”), is a potential technology for long-distance optical communication systems, especially power-limited submarine links.

High-capacity, long-haul MDM links have often used graded-index (“GI”) MMFs, as a consequence of their relatively low uncoupled group-delay (“GD”) standard deviation (“STD”). In these fibers, the spatial and polarization modes form mode groups. The propagation constants of modes from the same mode group are nearly equal, while those from different mode groups are significantly different. Random perturbations in these fibers cause strong intra-group mode coupling and weak inter-group mode coupling.

Practical implementation of MDM in MMF links requires strong coupling across all signal modes. Strong coupling reduces the standard deviation (“STD”) of link mode-dependent gain and loss (hereinafter collectively “MDL” unless otherwise indicated), thereby increasing average capacity and reducing outage probability. It also reduces group-delay (“GD”) STD. Systems with strong coupling accumulate GD and MDL STDs in proportion to the square root of the propagation length.

One way to improve inter-group coupling to manage the accumulation of MDL and modal dispersion is to periodically insert “mode scramblers” in the system. Mode scramblers effect random or deterministic coupling between modes propagating in a fiber. A mode scrambler may be implemented in a variety of ways, one of which is as a long-period fiber Bragg grating. Such gratings introduce a periodic variation to the refractive index, which causes coupling of the different modes. Since signals generally pass through multiple fiber Bragg gratings in an optical transmission link, the Bragg gratings should have minimal loss. However, conventional fiber Bragg gratings with a single sinusoidal period will couple guided modes (i.e., bound modes) as well as cutoff modes, which are not well-guided. Unfortunately, coupling to the cutoff modes lead to undesirable loss.

Managing GD spread is vital for reducing the complexity of digital signal processing in long-haul systems using multi-mode fibers. In addition to reducing GD spread via mode scrambling, it may also be reduced via mode permutation, which involves periodically exchanging power between slow and fast modes, or low-gain and high-gain modes. Like a mode scrambler, a mode permuter may be implemented as at least one long-period Bragg grating.

Since a signal must pass through many mode scramblers or mode permuters in a long-haul link, the MDL and mode-averaged loss (MAL) requirements for these devices are strict. In particular, for a Bragg-grating-based mode scrambler in a graded-index MMF, the power coupling from guided modes to unguided modes or cladding modes must be minimized. And Bragg-grating-based mode permuter must operate over a wide wavelength span, such as the C-band, in order to obtain low GD STD and/or MDL STD for all wavelength channels.

### SUMMARY

Embodiments of the invention provide a low-loss fiber Bragg grating, such as may be used in a long-haul, optical-fiber transmission link for the purposes of reducing MDL and GD, among other benefits.

The low-loss long-period fiber Bragg gratings disclosed herein may be used as a mode scrambler or a mode permuter. A mode scrambler induces a deterministic or random coupling between at least some of the modes propagating in the fiber, with a goal of approximately effecting full, uniform random coupling between all the modes, in order to reduce disparities between modal group delays, mode-dependent chromatic dispersions, and/or in mode-dependent gains or losses. A mode permuter induces a deterministic coupling between specific modes propagating in the fiber, typically interchanging a substantial fraction of the light between these modes. In typical applications, the permuter interchanges light between slow modes and fast modes, between more dispersive or less dispersive modes, or between strong modes and weak modes, with a goal of reducing disparities in group delays, mode-dependent chromatic dispersions, and/or mode-dependent gain/mode dependent losses. The term “mode coupler,” as used in this disclosure and the appended claims, references either or both of these devices.

In accordance with the present teachings, propagation-constant engineering is employed to achieve the aforementioned low-loss fiber Bragg grating. As used herein, the term “propagation constant engineering” refers to the process of adjusting the propagation constants of the transverse modes of a waveguide in a prescribed way. The design process disclosed herein involves optimizing the propagation constants of the guided and unguided transverse modes of the waveguide such that the longitudinal grating can induce desired mode interactions and avoid undesired mode interactions. In particular, the propagation constants are adjusted so that substantial desired coupling occurs between the guided modes, and less undesired coupling occurs to the cutoff modes. In this way, losses arising from coupling to undesired guided modes or to the cutoff modes are reduced.

The adjustments to the various propagation constants are made by perturbing the transverse refractive index profile (also known as the “radial refractive index profile”) of the multi-mode fiber in which the Bragg grating is fabricated. In particular, raising the refractive index at some radial positions and lowering the refractive index at other radial positions of the multi-mode fiber is effective in adjusting the propagation constants to desired values that induce desired coupling between guided modes while minimizing undesired coupling to cutoff modes.

Propagation of light in a fiber is governed by a wave equation, which is a partial differential equation (PDE). Given a transverse refractive index profile, the PDE can be solved to find the fields and the propagation constants of the modes, which are eigenvalues. The PDE can be solved analytically in special cases, and numerically in general. In designing the transverse index profile in accordance with the present teachings, this problem is solved in reverse. That is, starting with a desired set of propagation constants—the eigenvalues—a transverse refractive index profile is found that yields them. This process may be referred to as solving an inverse eigenvalue problem.

In the prior art, efforts to achieve the desired propagation constants were based on: (i) choosing a standard transverse refractive index profile, such as step-index or parabolic-index; or (ii) choosing a parameterized transverse index profile, such as an alpha-law graded-index profile; or (iii) adding discrete features, such as pedestals, cliffs and trenches, to the transverse index profile. Those designs typically resulted in high loss and low group-delay accumulation, or low loss and high group-delay accumulation.

In accordance with the present teachings, in contrast, the transverse index profile is systematically designed by a free-form refractive index (RI) optimization method, in which the radial coordinate is divided into discrete increments, and the refractive index in each radial increment is varied during the optimization procedure, while grid search optimization is used to determine an optimal longitudinal index profile, such as a sinusoidal grating. This design procedure yields an LPFG-based mode coupler (for both scramblers and permuters) that exhibits low loss and square-root accumulation of link MDL STD and GD STD. In fact, some embodiments of a mode coupler in accordance with the present teachings show better than square-root GD accumulation, indicating GD self-compensation.

In typical GI MMFs, the guided and lowest-order cutoff modes have nearly equally spaced propagation constants. Hence, a grating will induce coupling not only between all the guided modes but also to the lowest-order cutoff modes, causing high losses. In embodiments in accordance with the present teachings, the transverse refractive index profile of the mode scrambler is designed to yield equal spacing between the propagation constants of the guided mode groups and a different and larger propagation constant spacing between the highest-order guided modes and the lowest-order cutoff modes. Moreover, in accordance with embodiments of the invention, the highest-order guided modes cannot be phase-matched to any other unguided modes by a grating. This enables a uniform grating, obtained by a grid search optimization of the grating parameters, to couple all the guided mode groups with minimal loss.

An exemplary embodiment of a mode scrambler in accordance with the present teachings, which has a free-form-optimized refractive index profile, achieved MDL STD and MAL STD and less than 0.011 dB and 0.027 dB, respectively, over the C-band. The mode permuter, which has a free-form-optimized transverse profile, achieved MDL STD and MAL STD of less than 0.11 dB and 0.07 dB, respectively, over the C-band. Designs in accordance with the present teachings were numerically evaluated through link simulations, and the reduction in GD spread for different levels of random inter-group coupling in the fiber were quantified. The results show that in a link with periodic mode permutation and mode scrambling, the GD STD is reduced by a factor over 3.13 compared to a link relying solely on periodic mode scrambling.

In some embodiments, strong mode scrambling is ensured by estimating the group-delay standard deviation (a measure of modal dispersion) and/or the properties of a power-coupling matrix of the mode scrambler, which accelerates the design process.

Plural mode couplers in accordance with the present teachings are used to provide an improved transmission system, such as those that include long-distance terrestrial or undersea fiber-optic cables employing multi-mode fibers. In some embodiments disclosed herein, mode couplers (i.e., mode scramblers and permuters) are designed for optical-fiber transmission links employing graded-index transmission fibers with D=12 guided spatial and polarization modes. It is notable that although mode scramblers and mode permuters with fiber Bragg gratings have been developed for links accommodating D=6 guided spatial and polarization modes, there are no prior-art designs for links supporting a greater number of modes. Moreover, prior-art mode scramblers exhibit excessive loss due to coupling from guided to unguided modes, specifically cutoff modes.

A detailed treatment of embodiments in accordance with the invention is provided in the following publications, all of which are incorporated by reference herein:
O. Krutko, R. Refaee, A. Vijay and J. M. Kahn, “Ultra-Low-Loss Fiber Bragg Grating Mode Scrambler Design Exploiting Propagation Constant Engineering”, J. Lightw. Technol., vol. 43, no. 6, pp. 2883-2896 Mar. 15, 2025.
A. Vijay, O. Krutko, R. Refaee and J. M. Kahn, “Low-Loss Fiber Bragg Grating Mode Scramblers Exploiting Propagation Constant Engineering”, Proc. of Frontiers in Optics+Laser Science, Denver, CO, Sep. 23-26, 2024.
A. Vijay, O. Krutko, R. Refaee and J. M. Kahn, “Modal Statistics in Mode-Division-Multiplexed Systems Using Mode Scramblers”, J Lightw. Technol., vol. 43, no. 2, pp. 845-856, Jan. 15, 2025.
A. Vijay, O. Krutko, R. Refaee and J. M. Kahn, “Modal Statistics in Mode-Division-Multiplexed Systems Using Mode Scramblers (Extended)”, https://doi.org/10.48550/arXiv.2409.06908.
O. Krutko, R. Refaee, A. Vijay, N. Zahedi, and J. M. Kahn, “Low-Loss All-Fiber Mode Permuter Design Exploiting Propagation Constant Engineering and Cascaded Bragg Gratings”, https://arXiv.org/pdf/2505.06775.
A. Vijay, N. Zahedi, O. Krutko, R. Refaee, and J. M. Kahn, “Closed-Form Statistics and Design of Mode-Division-Multiplexing Systems Employing Group-Delay Compensation and Mode Permutation”, https://arXiv.org/pdf/2505.06773.

In some embodiments, the invention provides a system comprising a mode coupler comprising at least one waveguide section connected between a mode coupler input and a mode coupler output, the waveguide section supporting a set of guided coupler modes and a set of cutoff coupler modes, and having a transverse refractive index profile and a longitudinal refractive index profile, wherein the transverse refractive index profile is adjusted to yield a set of desired spacings between a set of propagation constants of the sets of coupler modes such that the longitudinal refractive index profile induces certain desired couplings between the guided coupler modes while inhibiting undesired couplings between the guided coupler modes and the cutoff coupler modes.

In some embodiments, the aforementioned longitudinal refractive index profile corresponds to a long-period Bragg grating, including variants thereof, such as chirped, tilted or asymmetric long-period Bragg gratings.

In some embodiments, the mode coupler of the aforementioned system is a mode scrambler, in some other embodiments, the mode coupler is a mode permuter, and is some further embodiments, the system includes mode couplers of both types.

In some embodiments, the aforementioned system includes an optical fiber transmission link for conveying a plurality of optical signals between a link input and a link output, the link including at least two segments of multimode fiber, and a plurality of the mode couplers, wherein each of the segments of multimode fiber support a plurality of guided modes, and further wherein at least one of the mode couplers is inserted between adjacent segments.

In some embodiments, the guided modes supported by the multimode fiber of the aforementioned system include:
a) faster modes that are subject to relatively shorter group delays and slower modes that are subject to relatively longer group delays, wherein the mode couplers redistribute the optical signals between the faster modes and the slower modes to reduce disparities between the accumulated group delays for different signals between the link input and the link output; and/or
b) stronger modes that are subject to relatively higher gains and weaker modes that are subject to relatively lower gains, wherein the mode couplers redistribute the optical signals between stronger modes and weaker modes to reduce disparities between accumulated gains for the optical signals between the link input and the link output; and/or
c) more dispersive modes that are subject to relatively higher chromatic dispersion and less dispersive modes that are subject to relatively lower chromatic dispersion, wherein the mode couplers redistribute the optical signals between the more dispersive modes and the less dispersive modes to reduce disparities between accumulated chromatic dispersion for different signals between the link input and the link output.

In some embodiments, the segments of multimode fiber in the aforementioned system are designed with relatively low mode-dependent chromatic dispersion, thereby facilitating group delay self-compensation.

In some embodiments, the segments of multimode fiber are designed to support D=12 guided modes, corresponding to 6 guided spatial modes, and in which the mode-group-averaged group delay of the two lowest-order mode groups is equal and opposite to the mode-group-averaged group delay of the highest-order mode group, where all group delays are measured relative to the average of the group delays over all the modes.

In some embodiments in which the mode coupler is a mode scrambler, a power coupling matrix that satisfies a first set of criteria defines the coupling between guided mode groups of the transmission link. And in some embodiments in which the mode coupler is a mode permuter, a power coupling matrix that satisfies a second set of criteria defines the coupling between guided mode groups of the transmission link.

Many further embodiments of the present invention are disclosed in the following Detailed Description and accompanying drawings.

### BRIEF DESCRIPTION OF THE DRAWINGS

FIG. 1 depicts a conventional long-period fiber Bragg grating.

FIG. 2 depicts an embodiment in accordance with the present teachings of a span of a long-haul transmission link, the span including at least one mode scrambler.

FIG. 3 depicts an embodiment in accordance with the present teachings of a span of a long-haul transmission link, the span including more than one mode scrambler.

FIG. 4 depicts an embodiment in accordance with the present teachings of a span of a long-haul transmission link, the span including at least one mode permuter and one mode scrambler.

FIG. 5 depicts an embodiment in accordance with the present teachings of a span of a long-haul transmission link, the span including more than one mode permuter and more than one mode scrambler.

FIG. 6 depicts the transverse index profile nᵢₙᵢₜ(r) and the real part of the mode-group-averaged effective indices β̅^{init}/k₀ of a transmission fiber in the prior art.

FIG. 7 depicts an embodiment of the method by which an initial transverse index profile and its propagation constants are modified to yield desired propagation constants in accordance with the present teachings.

FIG. 8 depicts multiple transverse index profiles obtained by transverse RI optimization for various normalized cutoff mode offset values, in accordance with the present teachings.

FIG. 9 depicts salient components of an embodiment of a mode permuter, consisting of four cascaded LPFGs, in accordance with the present teachings.

FIG. 10 depicts an example of an SI multimode fiber suitable for use as a mode permuter, showing transverse index profile, propagation constants, and propagation constant spacings in accordance with the present teachings.

FIG. 11 depicts an embodiment of a mode-permuter multimode fiber designed using free-form index optimization in accordance with the present teachings, showing transverse index profile, guided mode effective indices, and selected propagation constant spacings.

FIG. 12 depicts an embodiment of an optimized fiber refractive index profile for a multi-mode fiber, and showing a pedestal/cliff feature at the core-cladding boundary.

### DETAILED DESCRIPTION

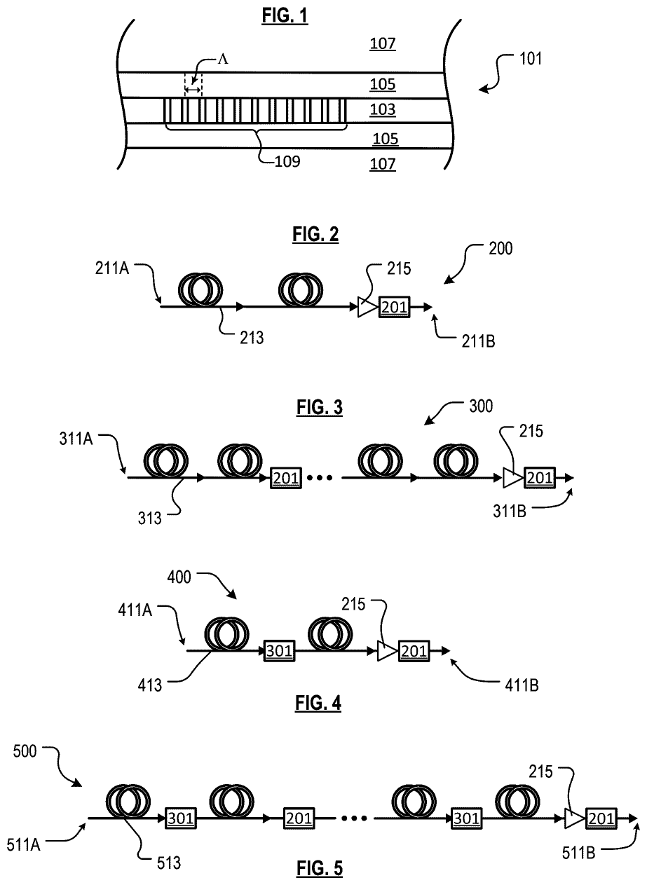

FIG. 1 depicts long-period fiber Bragg grating (hereinafter “LPFG”) 109 in core 103 of graded index MMF 101. Also depicted are inner cladding 105 and a portion of outer cladding 107. LFPG 109 has a. LPFG 109 is defined by a periodic modulation (period A) of refractive index along fiber core 103, but unlike conventional fiber Bragg gratings, the period of the modulation is much longer; that is, typically 100 μm to 1 mm, compared to about 0.5 μm for fiber Bragg gratings.

LPFG 109 forms the basis, after modification, for a mode coupler (i.e., mode scrambler and a mode permuter). In LPFG 109, the grading/variation of refractive index is along the optical axis and may be uniform across the width of fiber 101. In some other embodiments, variants of LPFG 109 may be used as the basis for the mode coupler. In particular, the refractive index profile of the grating may be modified: (1) to provide a linear variation in the grating period (i.e., a chirped fiber Bragg grating); (2) so that the variation of refractive index is at an angle to the optical axis (i.e., a tilted fiber Bragg grating); so that the refractive index modulation profile is not symmetric about the fiber axis or along the transverse dimension (i.e., an asymmetric fiber Bragg grating).

FIGS. 2-5 each depict a span of a long-haul transmission link. As used herein, the term “span” is a portion of the link between successive amplifier subsystems, each including both an inline amplifier, typically an erbium-doped fiber amplifier, and a mode coupler. A “segment” is a piece of multi-mode fiber of a given type.

In particular, FIG. 2 depicts one span 200 of a long-haul optical transmission link, including two segments 213 of multi-mode fiber, amplifier 215, and mode scrambler 201. Link input 211A and link output 211B are defined at respective ends of span 200. The two segments 213 are typically chosen to have compensating group delays. Mode scrambler 201 at the end of each span typically ensures that the group delay spread and the mode-dependent gain/loss from successive spans accumulate sub-linearly, typically in proportion to the square root of the number of spans.

FIG. 3 depicts one span 300 of a long-haul optical transmission link, including two segments 213 of multi-mode fiber, mode scrambler 201, two more segments 213 of multi-mode fiber, amplifier 215, and another mode scrambler 201. Link input 311A and link output 311B are defined at respective ends of span 300. Each pair of segments 213 is typically chosen to have compensating group delays, and mode scrambler 201 between successive pairs of segments 213 is typically intended to ensure that the group delay spread from successive pairs of segments 213 accumulates sub-linearly with the number of pairs. Mode scrambler 201 at the end of each span typically ensures that the group delay spread and the mode-dependent gain/loss from successive spans accumulate sub-linearly, typically in proportion to the square root of the number of spans.

FIG. 4 depicts one span 400 of a long-haul optical transmission link, including segment 213 of multi-mode fiber, mode permuter 301, another segment 213 of multi-mode fiber, amplifier 215, and mode scrambler 201. Link input 411A and link output 411B are defined at respective ends of span 400. The two segments 213 of multi-mode fiber may be chosen to have identical or different modal group delays, and in conjunction with intervening mode permuter 301, they effect group-delay self-compensation or compensation. Mode scrambler 201 at the end of each span typically ensures that the group-delay spread and the mode-dependent gain/loss from successive spans accumulate sub-linearly, typically in proportion to the square root of the number of spans.

FIG. 5 depicts one span 500 of a long-haul optical transmission link, including segment 213 of multi-mode fiber, mode permuter 301, another segment 213 of multi-mode fiber, mode scrambler 201, segment 213 of multi-mode fiber, mode permuter 301, another segment 213 of multi-mode fiber, amplifier 215, and another mode scrambler 201. Link input 511A and link output 511B are defined at respective ends of span 300. Each pair of segments 213 of multi-mode fiber with intervening mode permuter 301 may be chosen to have identical or different modal group delays, and in conjunction with intervening mode permuter 301, they effect group delay self-compensation or compensation. Mode scrambler 201 between successive pairs of segments 213 is typically intended to ensure that the group delay spread from successive pairs of segments 213 accumulates sub-linearly with the number of pairs. Mode scrambler 201 at the end of each span typically ensures that the group delay spread and the mode-dependent gain/loss from successive spans accumulate sub-linearly, typically in proportion to the square root of the number of spans.

Although both based on an LPFG (or a variant thereof), the design of a mode scrambler and design of a mode permuter vary significantly, as described further below, and in the aforementioned publications.

### Mode Scrambler Design.

In a mode scrambler in accordance with the present teachings, the design proceeds by jointly optimizing the transverse index profile and longitudinal grating to minimize the LPFG loss while ensuring sufficient coupling to induce square-root accumulation of GD and MDL in multi-span links. The design of the transverse index profile and grating are highly interdependent. For a uniform grating to effectively couple all the guided modes, the transverse index profile should ensure that the propagation constants of the guided modes are equally spaced. Moreover, to incur low losses, this spacing should significantly differ from the difference between the propagation constants of the highest-order guided modes and any unguided or cladding modes.

As previously mentioned, in accordance with the present teachings, the transverse index profile (for both mode scramblers and mode permuters) is systematically designed by a free-form refractive index (RI) optimization method, in which the radial coordinate is divided into discrete increments, and the refractive index in each radial increment is varied during the optimization procedure, while grid search optimization is used to determine an optimal longitudinal index profile, such as a sinusoidal grating. This design procedure yields an LPFG-based mode coupler that exhibits low loss and square-root accumulation of link MDL STD and GD STD.

The main objectives for the modal propagation constants in the mode scrambler fiber include: (i) equal spacing between the guided-mode groups; and (ii) a larger spacing between the highest-order guided modes and the unguided modes. Transverse RI optimization is used to systematically obtain transverse index profiles the satisfy objectives (i) and (ii).

Mode coupling by an LPFG is a coherent, phase-matched process. A grating couples two modes most efficiently when:

$$Δβ = 2 π / ∧ \qquad [ 1 ]$$

Where: Δβ is the difference between the modal propagation constants; and
   ∧ is the grating period
      Considering a simple case in which a MMF supports only two modes, the maximum coupling efficiency η between the modes achievable by a grating is:

$$η \approx 1 / [ 1 + {( ( Δβ - 2 π / ∧ ) / K )}^{2} ] \qquad [ 2 ]$$

Where: K is the coupling coefficient between the two modes induced by the grating;
   The self-coupling coefficients are assumed to be negligible.

A GI transverse index profile is often proposed for mode scramblers because its modes form mode groups with nearly equally spaced propagation constants, which can therefore all be coupled efficiently by a single uniform grating.

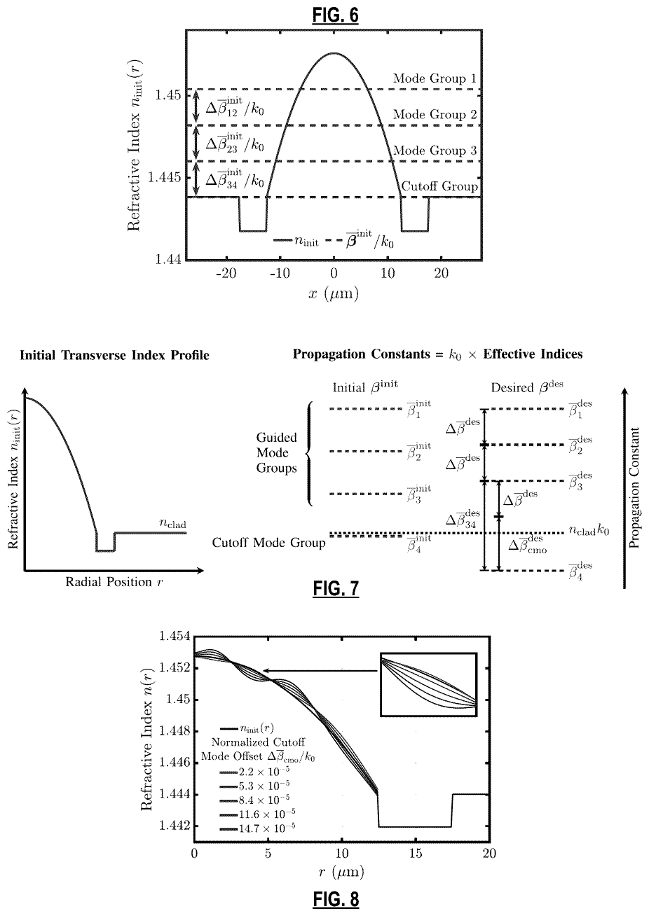

FIG. 6 depicts the transverse index profile nᵢₙᵢₜ(r) and the real part of the mode-group-averaged effective indices β̅^{init}/k₀ of the transmission fiber referenced in H. Srinivas, et al., “Efficient Integrated Multimode Amplifiers for Scalable Long-Haul SDM Transmission,” J. Lightwave Technology, v. 41, no. 15, pp. 4989-52 August 2023, conference Name: Journal of Lightwave Technology. Available at: https://ieeexplore.ieee.org/document/10064021. This publication is incorporated by reference herein. The fiber is a D=12, trench-assisted GI transmission fiber with a 12.5 μm core radius, 5 μm trench width and 125 μm outer diameter. The real parts of the mode-group-averaged effective indices β̅^{init}/k₀ are indicated by dashed lines, where k₀=2π/λ. The mode groups and effective index spacings between mode groups are indicated in FIG. 5.

The effective indices are obtained by dividing the propagation constants by k₀=2π/λ, where λ is the free-space wavelength. For this index profile, the guided modes are {LP_{01,x}, LP_{01,y}}, {LP_{11a,x}, LP_{11a,y}, LP_{11b,x}, LP_{11b,y}}, {LP_{02,x}, LP_{02,y}, LP_{21a,x}, LP_{21a,y}, LP_{21b,x}, LP_{21b,y}}, and the lowest-order cutoff modes are {LP_{12a,x}, LP_{12a,y}, LP_{12b,x}, LP_{12b,y}, LP_{31a,x}, LP_{31a,y}, LP_{31b,x}, LP_{31b,y}}.

The guided modes are grouped into N_{g}=3 mode groups whose propagation constants are nearly equally spaced. That is, Δβ̅^{init}₁₂≈Δβ̅^{init}₂₃, enabling a single uniform grating to couple all the modes. While this is beneficial, a mode scrambler using this transverse index profile will have high loss, since the highest-order guided modes will be coupled efficiently into unguided modes. The most problematic unguided modes are part of the lowest-order cutoff mode group, since Δβ̅^{init}₃₄≈Δβ̅^{init}₁₂≈Δβ̅^{init}₂₃, the highest-order guided modes are efficiently coupled to them by the grating.

The coupling coefficients between the highest-order guided modes and the lowest-order cutoff modes are larger in magnitude than those between the highest-order guided modes and any other unguided modes. These lowest-order cutoff modes are very nearly linearly polarized, transverse modes similar to the guided modes since their effective indices are close to the cladding index. These modes have significant power in the core and overlap substantially with the guided modes, resulting in efficient coupling. But the highest-order guided modes will also couple to other unguided modes, causing additional loss.

In accordance with the present teachings, to ensure efficient coupling between guided modes by a single grating, while minimizing coupling from the highest-order guided modes to unguided modes, the transverse index profile should yield propagation constants satisfying the following conditions:
C.1 The propagation-constant spacings between all the guided mode groups should be approximately equal: Δβ̅≈Δβ̅₁₂≈Δβ̅₂₃≈ . . . ≈Δβ̅_{Ng-1 Ng}.
C.2 The propagation-constant spacing between the highest-order guided mode group and the lowest-order cutoff mode group should not equal the spacing between guided mode groups: |Δβ̅−Δβ_{Ng Ng+1}|>>0, where |⋅| denotes absolute value.
C.3 The highest-order guided mode group should not be efficiently coupled to other unguided modes by a uniform grating that efficiently couples the guided modes: β̅_{Ng}−Δβ̅>>n_{clad}k₀.

It is notable that simply increasing the core-cladding RI contrast or core radius of a GI fiber will not yield a good design. With this change, the lowest-order cutoff mode group would become guided but still provide a pathway for power coupling out of the original guided modes used to transmit data.

FIG. 7 depicts the manner in which an initial transverse index profile and its propagation constants are modified to yield desired propagation constants that satisfy conditions C.1-C3. For the sake of clarity, the diagrams in this Figure are not drawn to scale.

FIG. 7 depicts the initial transverse index profile nᵢₙᵢₜ(r) of a trench-assisted GI fiber supporting N_{g}=3 guided mode groups, and the corresponding set of initial mode-group-averaged propagation constants β^{init}. At the right of the Figure, a set of desired mode-group-averaged propagation constants β^{des} satisfying conditions C.1-C.3 is depicted. In order to satisfy conditions C.1-C.3, Δβ̅^{des}₃₄ is set larger than Δβ̅^{des}, while Δβ̅^{des}₁₂ and Δβ̅^{des}₂₃ are set equal to Δβ des, which is smaller than Δβ̅^{init}₁₂ and Δβ̅^{init}₂₃. This embodiment defines an important design parameter related to C.2: the cutoff mode offset parameter Δβ̅^{des}_{cmo}=Δβ̅^{des}₃₄−Δβ̅^{des}. It is notable that many choices of the desired propagation constants β^{des} can satisfy conditions C.1-C.3.

After choosing the desired propagation constants β^{des}, a transverse RI optimization method described in K. Choutagunta and J. M. Kahn, “Designing High-Performance Multimode Fibers Using Refractive Index Optimization,” J. Lightwave Technology, v. 39, no. 1, pp. 233-242, January 2021, conference Name: Journal of Lightwave Technology, incorporated by reference herein, is used to find an axially symmetric transverse index profile n_{des}(r) yielding the desired propagation constants β^{des}. An objective function is defined based on the squared differences between the actual propagation constants β and desired propagation constants β^{des}:

$$J = {\sum }_{i ∈ {M}_{guided}} {( {β}_{i} - {{β}^{des}}_{i} )}^{2} + {ω}_{o} {\sum }_{i ∈ {M}_{cutoff}} {( Re \{ {β}_{i} - {{β}^{des}}_{i} \} )}^{2} \qquad [ 3 ]$$

Where: ω₀ is a weighting factor;
   M_{guided} is the set of guided mode indices; and
   M_{cutoff} is the set of mode indices of the lowest-order cutoff mode group.

The modes are indexed in decreasing order of the real part of the propagation constant. The real part of the propagation constants of the cutoff modes are used to remove the imaginary component corresponding to mode attenuation. Gradient descent is used to iteratively update the transverse index profile at each radial coordinate r as:

$$n ( r ) ← n ( r ) - μ \partial / \partial n ( r ) \qquad [ 4 ]$$

Where: μ is a step-size parameter that is chosen sufficiently small that perturbative modeling is valid. Details on computing the derivative ∂J ∂n(r) can be found in the publication “Designing High-Performance Multimode Fibers Using Refractive Index Optimization,” referenced above.

As a consequence of the high dimensionality of the transverse RI optimization, the desired propagation constants β^{des} may not be achievable by a smooth transverse index profile given a particular initial transverse index profile nᵢₙᵢₜ(r). Therefore, while the choice of the desired propagation constants β^{des} establishes a goal for the optimization, after convergence, the actual propagation constants β may differ from β^{des}. Further discussion of the transverse RI optimization is provided later in this specification.

As previously noted, the design of the scrambler uses a free-form refractive index (RI) optimization method is used to systematically design a transverse index profile (described above), and a grid search optimization to determine an optimal uniform sinusoidal grating. The grid search optimization is now described.

For convenience, the optimization is restricted to uniform, sinusoidal gratings, such as described by expression (3) in the publication “Ultra-Low-Loss Fiber Bragg Grating Mode Scrambler Design Exploiting Propagation Constant Engineering,” previously referenced. Consequently, what is sought is a combination of modulation depth χ, grating period ∧, grating length L, and grating tilt angle θ that minimizes the mode scrambler MDL STD σ^{MS}_{MDL} and MAL α^{MS}_{MAL} while ensuring a scaling of the link MDL STD σ_{MDL}(K) and GD STD σ_{GDS}(K) with the square root of the number of spans K:

$${σ}_{MDL} ( K ) = √ K {σ}_{MDL} ( 1 ) \qquad [ 5 a ]$$

$${σ}_{GD} ( K ) = √ K {σ}_{GD} ( 1 ) \qquad [ 5 b ]$$

σ_{MDL}(1), which is the MDL STD of a single span, to be the combined MDL STD of a mode scrambler and amplifier pair.

Rather than searching over all possible combinations of the modulation depth, grating period, grating length, and tilt angle, several simplifications are made based on prior work. A large tilt angle θ=85° is selected to ensure coupling between modes of different rotational symmetries. The search is also restricted to a coarse set of modulation depths. Modulation depth is not permitted to vary freely, because the optimization would tend to minimize the modulation depth, yielding low loss, but making the design overly sensitive to fabrication errors. In summary, the search space comprises a fixed tilt angle, a coarse grid of modulation depths, and a fine grid of grating periods and grating lengths.

To evaluate each grating design, an objective function, such as provided in the publication “Ultra-Low-Loss Fiber Bragg Grating Mode Scrambler Design Exploiting Propagation Constant Engineering” at expressions (16) and (17), is used. Evaluating the objective function at three wavelengths—1530 nm, 1550 nm, and 1565 nm, was found to be sufficient to obtain good performance over the entire C-band.

The transverse RI optimization previously mentioned is used to obtain multiple designs for a LPFG-based mode scrambler for MMF supporting D=12 guided spatial and polarization modes.

The trench-assisted GI transmission fiber discussed in “Efficient Integrated Multimode Amplifiers for Scalable Long-Haul SDM Transmission,” previously referenced, is used as the initial transverse index profile nᵢₙᵢₜ(r) for optimization. This profile is a good starting point because the guided mode groups have equal propagation constant spacing and the resulting optimized profiles remain similar to the initial transmission fiber, leading to low splicing loss. The propagation constants are set as follows: β̅^{des}₁=β̅^{init}₁, Δβ̅^{des}=Δβ̅^{des}₁₂=Δβ̅^{des}₂₃=Δβ̅^{init}₁₂−k₀×10⁻⁴ and ω₀=0.05, and vary the cutoff mode offset parameter Δβ̅^{des}_{cmo}=Δβ̅^{des}₃₄−Δβ̅^{des} from 0.4k₀×10⁻⁴ to 4k₀×10⁻⁴. The weight parameter ω₀ is small to ensure the optimization prioritizes equal spacing between the guided mode group propagation constants (condition C.1). In each gradient descent iteration, the transverse index profile is only allowed to vary within the core region, r<12.5 μm, and is smoothed by a Gaussian smoothing filter. About 400 iterations are needed to achieve convergence with a step size μ=5×10⁻⁶.

FIG. 8 depicts multiple transverse index profiles obtained by transverse RI optimization for various normalized cutoff mode offset values. Since the guided mode group spacings are not precisely equal for the optimized transverse profiles, the cutoff mode offset is taken as the difference between the propagation constant spacing of the highest-order guided mode group and the lowest-order cutoff mode group with the average propagation constant spacing of the guided mode groups:

$$Δ {\overline{β}}_{c m o} = {\overline{β}}_{3} - {\overline{β}}_{4} - ( {\overline{β}}_{1} - {\overline{β}}_{3} ) / 2 = Δ {\overline{β}}_{34} - Δ {\overline{β}}_{13} / 2 \qquad [ 6 ]$$

The cutoff mode offsets are normalized by k₀ to be expressed in terms of effective indices. The larger the cutoff mode offset is chosen to be, the more the optimized RI profile differs from the initial profile. Compared to the initial profile, the optimized profiles have higher RI for 5.2 μm<r<8.5 μm. Depending on the cutoff mode offset parameter, the optimized profiles have a higher RI for 0 μm<r<2.4 μm and a lower RI for 8.5 μm<r<12.5 μm or vice versa. The optimized profiles take this form because, in each optimization step, the RI update at a specific spatial coordinate is a weighted linear combination of the modal intensities at that coordinate, where the weights are the relative errors between the actual and desired propagation constants. This insight is used to evaluate the optimized transverse index profile with normalized cutoff mode offset equal to 14.7×10-5 (see FIG. 7).

As previously noted, the optimized transverse index profiles may not achieve the set of desired propagation constant β^{des}. For each of the optimized transverse index profiles, the cutoff mode offset and the guided mode difference are evaluated. The guided mode difference is given by:

$$Δ {\overline{β}}_{gmd} = \vert Δ {\overline{β}}_{12} - Δ {\overline{β}}_{3} \vert \qquad [ 7 ]$$

A transverse index profile with a large guided mode difference Δβ_{gmd} might prevent a grating from achieving sufficient intergroup coupling. Additional discussion of the transverse RI optimization method for use in mode scrambler design is provided in “Ultra-Low-Loss Fiber Bragg Grating Mode Scrambler Design Exploiting Propagation Constant Engineering” at Section III.A.

Finally, a mode scrambler design is obtained by using the grid search optimization algorithm to find a combination of grating parameters for each of the optimized transverse index profiles identified above. More particularly, a numerical mode solver discussed in Section II.A of “Ultra-Low-Loss Fiber Bragg Grating Mode Scrambler Design Exploiting Propagation Constant Engineering” is used to computer the electric field profiles and propagation constants of the guided and unguided modes. The inventors found that to accurately model mode scrambler losses, it is sufficient for the coupled-mode propagation equations to use the 50 unguided modes with the closest phase match and largest coupling coefficients to the highest-order guided modes. Also evaluated are the group delays per unit length of the guided modes.

Further details of using the grid search optimization algorithm are discussed in Section III.B of “Ultra-Low-Loss Fiber Bragg Grating Mode Scrambler Design Exploiting Propagation Constant Engineering.” In that section, optimal grating parameters for the optimized transverse refractive index profile are presented, and shown below in TABLE I:

TABLE I
Optimal Grating Parameters for Optimized Transverse RI Profile

| | Grating | | Mode Scrambler | |
|---|---|---|---|---|
| Modulation | Period ∧ | Length ∧ | MAL | MDL STD |
| Depth | (μm) | (μm) | α^{MS}_{MAL} (dB)* | σ^{MS}_{MDL} dB)* |
| 5 × 10⁻⁵ | 743.1 | 4.42 | 0.011 | 0.026 |
| 10 × 10⁻⁵ | 746.0 | 2.12 | 0.026 | 0.039 |
| 15 × 10⁻⁵ | 749.0 | 1.98 | 0.068 | 0.066 |
| 20 × 10⁻⁵ | 747.8 | 1.01 | 0.082 | 0.076 |

*Maximum over C-band

Although effective, the criteria used above to design and analyze mode scramblers are restrictive, and evaluating mode scrambler performance requires brute-force multi-section simulations of the end-to-end transmission system to quantify GD spread and overall MDL. These multi-section simulations can significantly slow down iterative design procedures employing performance objectives of end-to-end GD or MDL STD.

The inventors have developed analytical tools that impose less restrictive design criteria and enable faster evaluation of performance objectives for mode scramblers. It has been determined that a mode-group power coupling matrix is a sufficient description of the mode scrambling induced by a mode scrambler. In particular, the structure and eigenvalues of the power coupling matrix emerge as the design criteria relevant for achieving strong coupling. This approach can dramatically speed up the design and optimization of mode scramblers.

The design criteria for a strong mode coupler are presented below. A complete mathematical treatment of the mode-group power coupling matrix and its application to the design of a mode scrambler is provided in “Modal Statistics in Mode-Division-Multiplexed Systems Using Mode Scramblers,” previously referenced.

P is the N_{g}×N_{g} mode-group power coupling matrix of the mode scrambler. The i, j element of P is defined as the power transferred by the mode scrambler from mode group j to mode group i:

$$P [ i j ] = {\sum }_{l ∈ {M}_{i}} {\sum }_{m ∈ {M}_{i}} {\vert R [ l , m ] \vert}^{2} \qquad [ 8 ]$$

Where: R is the mode scrambler transfer matrix
   The diagonal elements of P indicate the power retained by each mode group after transmission through the mode scrambler. In the case without mode scramblers, R and P become diagonal matrices. D is the N_{g}×N_{g} diagonal matrix of mode group degeneracy, D[i,ii]=dᵢ.

A practical mode scrambler device is not power-conserving and will exhibit MDL. However, a well-designed mode scrambler should have low intrinsic MDL. Hence, the dominant eigenvalue of D⁻¹P will be close to 1. The conditions on D⁻¹P for a mode scrambler such that the GD and MDL STDs are proportional to the square root of K are:
1) D⁻¹P is a primitive matrix. A matrix B∈C^{n×n} is said to be irreducible if and only if for any two distinct indices 1≤i, j≤n, there is a sequence of nonzero elements of B of the form {B[i, i₁], B[i₁, i₂], . . . , B[iₘ, j]}. B is said to be “primitive” if it has real non-negative entries and there exists a positive integer k for which every entry in Bk is positive. A primitive matrix is a special case of a non-negative irreducible matrix such that only one eigenvalue has an absolute value equal to its spectral radius. It should be noted that: P is primitive=⇐⇒D⁻¹P is primitive.
2) The non-dominant eigenvalues of D⁻¹P should be close to zero.

These conditions can be understood as follows. In the condition 1, the power coupling matrix implies all mode groups interact with each other in one or more passes through the mode scrambler. Condition 2 is related to the convergence rate. If the non-dominant eigenvalues are typically much smaller than 1 (less than 0.5), then (D⁻¹P)^{k}≈λ₁^{K} u₁u₁^{T} is valid even for smaller values of k. The non-dominant eigenvalues of D⁻¹P₂ are smaller in magnitude than those of D⁻¹P₁. Hence, the GD and MDL STDs corresponding to P₁ are higher than those of P₂.

### Mode Permuter Design.

In accordance with the present teachings, GD STD is minimized by co-designing a transmission fiber and a mode permuter. More specifically, the modal GDs of the transmission fiber must satisfy a certain relation, and the mode permuter must exchange power between specific pairs of modes. In some embodiments, the mode permuter is a cascade of LPFGs, each designed to efficiently execute a subset of the necessary mode permutations. Preferably, all gratings are inscribed in the same fiber to simplify fabrication and minimize splicings. This constrains the design of the mode permuter's transverse index profile.

The following presents a summary of a theoretical framework for evaluation the GD STD of self-compensated links using a GI transmission fiber with N_{g} mode groups and D spatial and polarization modes. A complete mathematical treatment is provided in “Low-Loss All-Fiber Mode Permuter Design Exploiting Propagation Constant Engineering and Cascaded Bragg Gratings,” previously referenced.

The N_{g}×N_{g} mode-group power coupling matrix of the mode permuter has a form similar to expression [8] for the mode scrambler, and is given by:

$${P}_{MP} [ i , j ] = {\sum }_{l ∈ {M}_{i}} {\sum }_{m ∈ {M}_{i}} {\vert {R}_{MP} [ l , m ] \vert}^{2} \qquad [ 9 ]$$

Where: R_{MP} is the D×D transfer matrix
   The i, j element of P_{MP} is defined as the power the mode permuters transfers from mode group Mᵢ to mode group Mⱼ.

The GD STD of the self-compensated span is given by:

$${σ}_{GD} = √ ( E \{ {‖ {τ}_{tot} ‖}^{2} \} / D ) \qquad [ 10 ]$$

In the absence of random inter-group coupling and assuming a negligible intra-group GD STD, E {∥τₜₒₜ∥²} denotes the expected squared norm of the coupled GDs and is given by:

$$E \{ {‖ {τ}_{tot} ‖}^{2} \} = 2 {τ}_{0}^{H} D {τ}_{0} + 2 {τ}_{0}^{H} {P}_{MP} {τ}_{0} \qquad [ 11 ]$$

Where: D is the N_{g}×N_{g} diagonal matrix of mode group degeneracy,
   D[i,i]=dᵢ.
      Since R_{MP} is a unitary matrix, the constraints on the entries of P_{MP} are given by:

$${P}_{MP} [ i , j ] \geq 0 , 1 \leq i , j \leq {N}_{g} , \qquad [ 12 A ]$$

$${D}^{- 1} {P}_{MP} {1}_{N g} = {1}_{N g} , \qquad [ 12 B ]$$

$${d}^{T} {D}^{- 1} {P}_{MP} = {d}^{T} \qquad [ 12 C ]$$

Where: d^{T} is the transpose of the mode group degeneracy vector.
   In Expression [12B], 1_{Ng} denotes the all-ones column vector of dimension N_{g}. Finding the optimal P_{MP} to minimize expression under the constraints in expressions [12A]-[12C] is a convex optimization problem.

Consider a transmission link using D=12-mode, graded index transmission fiber with 3 mode groups N_{g} and d=[2, 4, 6]^{T}. The fiber has the following signal modes, each with two polarizations: {LP₀₁}, {LP₁₁ₐ, LP_{11b}}, {LP₀₂, LP₂₁ₐ, LP_{21b}}.

Minimizing expression requires a specific combination of τ₀ and P_{MP}. E {∥τₜₒₜ∥²}=0 when

$${τ}_{0 , 1} = {τ}_{0 , 2} = - {τ}_{0 , 3} , \qquad [ 13 A ]$$

$${P}_{MP} = 2 [ \begin{matrix}0 & 0 & 1 \\ 0 & 0 & 2 \\ 1 & 2 & 0\end{matrix} ] \qquad [ 13 B ]$$

This combination of τ₀ and P_{MP} requires the GDs of the first two mode groups to be equal and opposite to those of the third mode group, while the mode permuter must exchange all power between the third mode group and the first two mode groups.

A method for the design of a D=12-mode LPFG-based mode permuter that exchanges all power between the third mode group and the first two mode groups is now presented.

Numerous mode permutations can yield the optimal mode-group-summed power coupling matrix P_{MP} in (13b). Due to differing mode field symmetries, exchanging power between LP₀₁ and LP_{0z} and between LP₁₁ and LP₂₁ is best. In the spatial mode basis {LP₀₁, LP₁₁ₐ, LP_{11b}, LP₀₂, LP₂₁ₐ, LP_{21b}}, the transfer matrix of these mode permutations is given by:

$${R}_{M P =} [ \begin{matrix}0 & 0 & 0 & 1 & 0 & 0 \\ 0 & 0 & 0 & 0 & 1 & 0 \\ 0 & 0 & 0 & 0 & 0 & 1 \\ 1 & 0 & 0 & 0 & 0 & 0 \\ 0 & 1 & 0 & 0 & 0 & 0 \\ 0 & 0 & 1 & 0 & 0 & 0\end{matrix} ] \qquad [ 14 ]$$

Since only the power is relevant, the phase of each entry can be arbitrary as long as R_{MP} remains unitary.

The transfer matrix in may be obtained two ways. One is to cascade two gratings: {LP₀₁-LP₀₂, LP₁₁-LP₂₁}. The second way is to cascade four gratings: {LP₀₁-LP₁₁ₐ, LP₁₁ₐ-LP₀₂, LP₀₁-LP₁₁ₐ, LP₁₁-LP₂₁}. In this case, the first three gratings perform the LP₀₁ and LP₀₂ power exchange by transferring power through LP₁₁ₐ. The four-grating cascade performs best. Although the two-grating cascade uses fewer gratings, the LP₀₁-LP₀₂ grating requires a mode permuter fiber with a core-cladding index difference significantly larger than that of the transmission fiber to prevent the grating from also coupling the LP₂₁ and LP₀₂ modes into unguided modes. The four-grating cascade solely transfers power between modes of adjacent mode groups, so the core-cladding index difference can be lower. As a result, the splicing loss between the mode permuter fiber and the transmission fiber is significantly lower for the four-grating cascade than for the two-grating cascade. One disadvantage of the four-grating cascade is that the efficiencies of the LP₀₁-LP₁₁ₐ and LP₁₁ₐ-LP₀₂ mode conversions are degraded by the instability of the LP_{11a,x} and LP_{11a,y} modes, which periodically convert to LP_{11b,y} and LP_{11b,x}, respectively, according to the beat lengths of the TE₀₁/HE₂₁ and TM₀₁/HE₂₁ vector mode pairs that compose the LP₁₁ modes. Although this impairs the mode conversion efficiency, the reduced splicing loss is a considered to be a preferable trade-off.

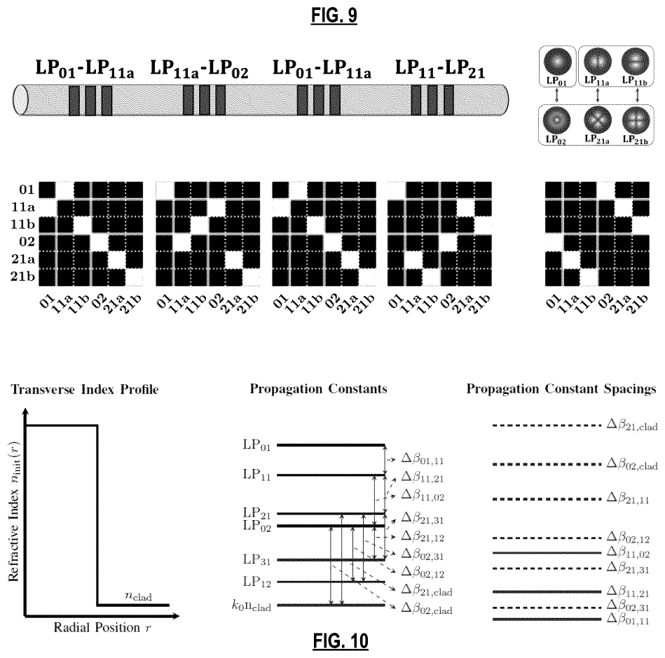

FIG. 9 depicts key components of an illustrative mode permuter, consisting of four cascaded LPFGs. The first three gratings facilitate the exchange between LP₀₁ and LP₀₂, using LP₁₁ₐ as an intermediate state. The last grating exchanges both LP₁₁ modes with both LP₂₁ modes. The ideal transfer matrices for the individual gratings, as well as their combination, are shown in the basis of LP spatial modes. To implement the proposed mode permuter, three gratings must be designed: LP₀₁-LP₁₁ₐ, LP₁₁ₐ-LP₀₂, and LP₁₁-LP₂₁. To reduce the number of splices needed, this embodiment uses the same fiber for all gratings. This choice makes designing the mode permuter fiber's transverse index profile more challenging, yet simplifies its fabrication.

As previously noted, in embodiments of the invention, GD STD is minimized by co-designing a transmission fiber and a mode permuter, and the modal GDs of the transmission fiber must satisfy a certain relation. The following disclosure summarizes some aspects of mode permuter fiber transverse index design; a complete mathematical treatment is provided in “Low-Loss All-Fiber Mode Permuter Design Exploiting Propagation Constant Engineering and Cascaded Bragg Gratings,” previously referenced.

Mode coupling by an LPFG is a coherent, phase-matched process. A uniform grating couples two modes most efficiently when Δβ=2π/∧, in accordance with expression [1], and, for a case in which an MMF supports only two modes, the maximum coupling efficiency, η, is given by η≈1/[1+ ((Δβ−2π/∧)/K)²], in accordance with expression [2]. The grating length for the greatest power transfer occurs at length:

$${L}_{c} = π / ( 2 \vert κ \vert ) \qquad [ 15 ]$$

For coupling between mode i, LPₗₘ, and mode j, LP_{l′m′}, the propagation constant spacing is denoted as:

$${Δβ}_{lm , {l}^{′} {m}^{′}} = \vert β [ i ] - β [ j ] \vert \qquad [ 16 ]$$

Mode permutation relies on controlled, complete power exchanges between particular pairs of modes. To achieve this, we require the D=12-mode permuter fiber to satisfy the following design criterion:
C.PF: The propagation constant spacings of the desired mode exchanges LP₀₁-LP₁₁, LP₁₁-LP₀₂, and LP₁₁-LP₂₁ must be well separated from each other and from every spacing between a signal mode and any other signal, guided non-signal, or unguided mode.
   If design criterion C.PF is satisfied, the LP₀₁-LP₁₁ₐ, LP₁₁ₐ-LP₀₂, and LP₁₁-LP₂₁ gratings can be inscribed in the same mode permuter fiber, each performing their desired mode exchanges with high coupling efficiency while exhibiting low loss and minimal unwanted coupling.

GI-MMFs that have been suggested for mode scramblers or long-haul transmission fibers are inadequate for a mode permuter in accordance with the present teachings. This inadequacy arises because the propagation constant spacings between modes of adjacent mode groups are nearly identical, and the LP₀₂ and LP₂₁ modes are nearly degenerate. As a result, it becomes impossible to couple specific pairs of modes without unintentionally coupling others. In contrast, step-index multimode fibers (“SI-MMFs”) do not have these properties and thus are a more suitable option.

Two approaches are considered for the transverse index profile designs. In one, the design is restricted to the aforementioned SI profile. In the other, free-form index optimization as disclosed in “Designing High-Performance Multimode Fibers Using Refractive Index Optimization” is used to find an improved design.

In both cases, two objectives are followed as a guide to design. Firstly, the MAL and MDL STD from splicing between the transmission fiber and the mode permuter fiber should be minimized to reduce device loss. Secondly, the separation between the desired transitions and adjacent transitions should be maximized to minimize unwanted coupling to guided or unguided modes.

The transverse and longitudinal index profiles of the LP₀₁-LP₁₁ₐ, LP₁₁ₐ-LP₀₂, and LP₁₁-LP₂₁ gratings are designed as follows.

Given a transverse index profile with propagation constant spacings satisfying design criterion C.PF, the design of each grating follows the same phase-matching principles relevant to the design of low-loss and large bandwidth LPFG-based mode converters described in the following references, each of which is incorporated by reference herein:
Y. Ma, et al., “High-Order OAM Mode Generator Using Multi-Cascaded Long-Period Fiber Gratings,” IEEE Photonics Technology Letters, v. 35, no. 8, pp. 434-437, April 2023.
X. Wang, et al., “Efficient Mutual Conversion of High-Order Core Mode in Few-Mode Fiber Employing Long Period Fiber Gratings,” J. Lightwave Technology, v. 42, no. 7, pp. 2464-2472 April 2024.
--, “Broadband conversion between high-order angular modes based on double-sided exposure long-period fiber grating,” Optics Express, v. 32, no. 22, p. 40060, October 2024.
X. Zhao, et al., “Mode converter based on the long-period fiber gratings written in the six-mode fiber,” in 2017 16th International Conference on Optical Communications and Networks (ICOCN), August 2017, pp. 1-3.

In some embodiments, the gratings are chirped and sinusoidal, with the total refractive index (RI) for each grating in the mode permuter given by:

$${n}_{t o t} ( r , θ , z ) = n ( r ) + Δ {n}_{g} ( r , θ ) ( 1 + cos ( 2 π z / Λ + ϕ ( z ) ) ) \qquad [ 17 ]$$

Where: n(r) is the mode permuter fiber's transverse index profile,
   Δn_{g}(r, θ) is the grating transverse index profile change induced by single- or multi-sided UV illumination,
   φ(z) is the longitudinal chirp profile.
      Each grating will be inscribed with one or more UV illuminations. Therefore, for each grating, the transverse index profile and following grating parameters must be determined: modulation depth χ, UV illumination angle(s) ψ, grating period ∧, grating length L_{g}, and chirp profile φ(z).

As discussed in “Low-Loss All-Fiber Mode Permuter Design Exploiting Propagation Constant Engineering and Cascaded Bragg Gratings” (see Section III.D), first, the transverse index profile for each grating is determined. Next the longitudinal index of the grating is determined.

In Section IV, the design methodology presented above (and in Section III of the referenced publication) is employed to design two LPFG-based mode permuters-one for the SI fiber and one for the free-form optimized fiber—for a long-haul MDM link that supports D=12 spatial and polarization modes. The design based on the free-form optimized fiber is described briefly below.

The process consists of four phases, each with a different number of iterations N, weighting vector w, step size μ, and set of target propagation constants {β^{tar}[l m]} over all guided modes LPₗₘ.

In phase 1, starting with the transmission fiber as the initial state, N₁ iterations are performed with:

$${β}^{tar} = {β}^{SI}$$

for all guided modes, where β^{SI} are the propagation constants of the SI-MMF depicted in FIG. 10.

In phase 2, N₂ iterations are performed with:

$${β}^{tar} [ 02 ] = {β}^{S I} [ 02 ] - δ ,$$

and the rest of the β^{tar} are identical to β^{SI}. In the SI fiber, the LP₁₁-LP₀₂ transition is close to the transitions adjacent to it on each side, causing some undesired coupling. Phase 2 rectifies this in the optimized design by shifting the LP₀₂ mode downwards, thus reordering the spacings to create more separation from the LP₁₁-LP₀₂ transition. This slight modification increases the separation between the LP₁₁-LP₀₂ transition and all adjacent transitions by 50%, substantially reducing parasitic coupling.

In phase 3, N₃ iterations are performed with:

$${β}^{tar} [ 11 ] = {β}^{SI} [ 11 ] + δ ,$$

$${β}^{tar} [ 21 ] = {β}^{SI} [ 21 ] + δ ,$$

and the rest of the β^{tar} are identical to β^{SI}. This shifts LP₁₁ and LP₂₁ upwards, further separating all couplings and isolating the desired transitions.

In phase 4, the last stage, fine-tuning consists of N₄ iterations with the {β^{tar}} identical to those in Phase 3, but with the weightings changed to target undesired transitions that continue to interfere with the ideal permutation scheme. More iterations would isolate the desired transitions even further, but the additional RI perturbations cause more splicing loss. The value of N₄ is selected to reflect the best compromise.

After sweeping each hyperparameter, the following setting are used:

$$δ = 6 {k}_{0} \times 1 {0}^{- 4} .$$

$${N}_{1} = 250 , {N}_{2} = 40 , {N}_{3} = 25 , and {N}_{4} = 15 .$$

The step size μ is 5×10⁻⁶ for Phases 1-3 and is halved in Phase 4.
The weighting w is increased by a factor of 4 for the particular mode or modes targeted in each phase and by a factor of 2 for the guided non-signal modes.

FIG. 11 depicts the transverse index profile, effective indices, and propagation constant spacings for the embodiment of a mode permuter obtained with free-form index optimization. The splicing MAL and MDL STD are smaller compared to the SI-based design, having values under 0.03 dB and 0.02 dB, respectively. The propagation constant spacings Δβ_{01,11}, Δβ_{11,02}, and Δβ_{11,21} vary over wavelength by 67.1 m⁻¹, 26.7 m⁻¹, and 57.5 m⁻¹, respectively. The separation between the LP₀₁-LP₁₁, LP₁₁-LP₀₂, and LP₁₁-LP₂₁ transitions and adjacent transitions is greater than 875 m⁻¹, excluding the inefficient LP₀₂-LP₃₁ transition. The beat lengths of the TE₀₁/HE₂₁ and TM₀₁/HE₂₁ modes increase to about 0.78 m and 5.7 m, respectively.

The transverse index profile of the free-form optimized fiber, as depicted in FIG. 10, more closely resembles transmission fiber than the SI fiber does, explaining the low splicing loss. (See FIGS. 2A and 5A in “Low-Loss All-Fiber Mode Permuter Design Exploiting Propagation Constant Engineering and Cascaded Bragg Gratings”). This was achieved while further isolating the desired transitions. The greater consistency of the propagation constant spacings across all wavelengths and the longer beat lengths of LP₁₁ improve the coupling efficiency as well.

As previously noted, the excessive accumulation of group-delay (GD) spread increases computational complexity and affects tracking of receiver-based multi-input multi-output signal processing, posing challenges to long-haul mode-division multiplexing in multimode fiber (MMF). GD compensation to reduce GD spread, such as implemented by a mode permuter, involves periodically exchanging propagating signals between modes with lower and higher GDs. The subject of group-delay compensation in multi-mode fibers systems is addressed in detail in the publication “Closed-Form Statistics and Design of Mode-Division-Multiplexing Systems Employing Group-Delay Compensation and Mode Permutation,” previously referenced. The following summarizes several salient issues discussed in the publication.

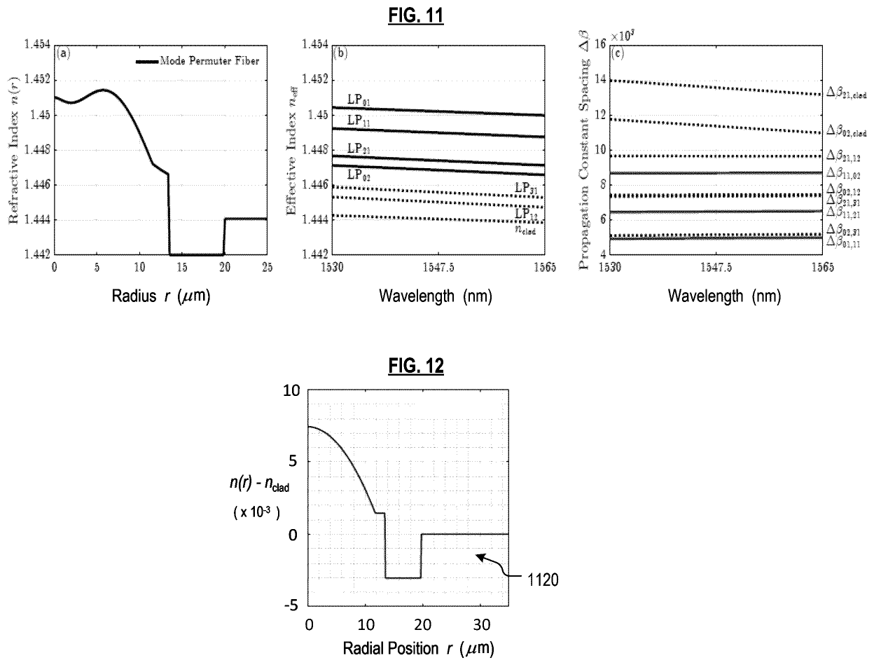

A challenge to the effectiveness of GD compensation is the wavelength dependence of relevant fiber GD properties, particularly mode-dependent chromatic dispersion (MDCD). A large MDCD can result in significant variations in effective GD STD across different wavelength channels. This is undesirable because receiver DSP complexity is dictated by the channel with the highest GD STD. Fiber designs should therefore aim to minimize MDCD. As such, pedestal-like features may be inserted into the refractive index profile. FIG. 12 depicts an optimized fiber refractive index profile relative to the cladding index for a multi-mode fiber, and showing a pedestal/cliff feature at the core-cladding boundary, which can be adjusted to control the chromatic dispersion of the fiber.

Fiber fabrication errors also pose a challenge to GD compensation. It is essential to assess their impact and design fibers with GD properties that maintain effective compensation despite imperfect fabrication. During system integration, manufactured fibers can be characterized, and fibers with compatible GD orderings can be selected for use in the same span to enhance compensation efficacy.

Self-compensation (i.e., use of one type of fiber) can achieve perfect compensation of inter-group GD spread when Linter (the inter-group coupling length) approaches infinity under the following conditions. Only one fiber type is used, τ₂=τ₁. For N_{g}=3, the average delays of the first two mode groups are equal in magnitude and sign. The average delay of the third mode group is equal in magnitude but opposite in sign to that of the first two mode groups: τ_{1,1}=τ_{1,2}=−τ_{1,3}. A mode permuter that transfers all the power from the first two mode groups to the third mode group, and vice versa, is needed between the two segments. It has a power coupling matrix given by:

$${P}_{MP} = [ \begin{matrix}0 & 0 & 2 \\ 0 & 0 & 4 \\ 2 & 4 & 0\end{matrix} ]$$

For this choice of τ₁ and P, τ₁^{T} Dτ₁+τ₁^{T} Pτ₁=0. This is the only configuration that achieves zero GD STD for MDM systems with mode-group degeneracies d=[2, 4, 6]^{T}.

It is to be understood that the disclosure teaches just some examples of embodiments in accordance with the invention and that many variations of the invention can easily be devised by those skilled in the art after reading this disclosure and that the scope of the present invention is to be determined by the following claims.

What is claimed:

1. A system comprising a mode coupler comprising at least one waveguide section connected between a mode coupler input and a mode coupler output, the waveguide section supporting a set of guided coupler modes and a set of cutoff coupler modes, and having a transverse refractive index profile and a longitudinal refractive index profile, wherein
the transverse refractive index profile is adjusted by free-form optimization to yield a set of desired spacings between a set of propagation constants of the sets of coupler modes such that the longitudinal refractive index profile induces desired couplings between the guided coupler modes, while inhibiting undesired couplings between the guided coupler modes and the cutoff coupler modes, and undesired couplings between the guided coupler modes.

2. The system of claim 1 in which the transverse refractive index profile of the mode coupler is optimized by a method including an inverse eigenvalue problem.

3. The system of claim 1 wherein the longitudinal refractive index profile corresponds to a long-period Bragg grating.

4. The system of claim 3 wherein the Bragg grating is chirped.

5. The system of claim 3 wherein the Bragg grating is tilted.

6. The system of claim 3 wherein the Bragg grating is asymmetric.

7. The system of claim 1 wherein the mode coupler is a mode scrambler.

8. The system of claim 1 wherein the mode coupler is a mode permuter.

9. The system of claim 1 wherein the system comprises an optical fiber transmission link for conveying a plurality of optical signals between a link input and a link output,
the link including at least two segments of multimode fiber, and a plurality of the mode couplers, wherein each of the segments of multimode fiber support a plurality of guided modes, and further wherein at least one of the mode couplers is inserted between adjacent segments.

10. The system of claim 9 wherein the guided modes include faster modes that are subject to relatively shorter group delays and slower modes that are subject to relatively longer group delays,
the link conveying the plurality of optical signals in at least the plurality of guided modes, and wherein the mode couplers redistribute the optical signals between the faster modes and the slower modes to reduce disparities between the accumulated group delays for different signals between the link input and the link output.

11. The system of claim 9 wherein the guided modes include stronger modes that are subject to relatively higher gains and weaker modes that are subject to relatively lower gains,
the link conveying the plurality of optical signals in at least the plurality of guided modes, and wherein the mode couplers redistribute the optical signals between stronger modes and weaker modes to reduce disparities between accumulated gains for the optical signals between the link input and the link output.

12. The system of claim 9 wherein the guided modes include more dispersive modes that are subject to relatively higher chromatic dispersion and less dispersive modes that are subject to relatively lower chromatic dispersion,
the link conveying the plurality of optical signals in at least the plurality of guided modes, and wherein the mode couplers redistribute the optical signals between the more dispersive modes and the less dispersive modes to reduce disparities between accumulated chromatic dispersion for different signals between the link input and the link output.

13. The system of claim 10 wherein the segments of multimode fiber are designed with relatively low mode-dependent chromatic dispersion, thereby facilitating group delay compensation.

14. The system of claim 10 wherein the segments of multimode fiber are designed to support D=12 guided modes, corresponding to 6 guided spatial modes, and in which the mode-group-averaged group delay of the two lowest-order mode groups is substantially equal and opposite to the mode-group-averaged group delay of the highest-order mode group, where all group delays are measured relative to the average of the group delays over all the modes.

15. The system of claim 9 wherein the mode coupler is a mode scrambler, wherein a power coupling matrix defines the coupling between guided mode groups of the transmission link induced by coupling between guided modes of the mode coupler, wherein the power coupling matrix satisfies the following criteria:
a) D⁻¹ P is a primitive matrix; and
b) non-dominant eigenvalues of D⁻¹ P are much less than 1,
wherein: P is the N_{g}×N_{g} mode-group power coupling matrix of the mode scrambler; and
D is the N_{g}×N_{g} diagonal matrix of mode group degeneracy.

16. The system of claim 9 wherein the mode coupler is a mode permuter, wherein a power coupling matrix defines the coupling between guided mode groups of the transmission link induced by coupling between guided modes of the mode coupler, wherein the power coupling matrix satisfies the following criteria:
$${P}_{MP} [ i , j ] \geq 0 , 1 \leq i , j \leq {N}_{g} , \qquad a )$$
$${D}^{- 1} {P}_{MP} {1}_{N g} = {1}_{N g} , \qquad b )$$
$${d}^{T} {D}^{- 1} {P}_{MP} = {d}^{T} \qquad c )$$
wherein: P_{MP}[i,j] is the N_{g}×N_{g} mode-group power coupling matrix of the mode permuter,
D is the N_{g}×N_{g} diagonal matrix of mode group degeneracy, and
d^{T} is the transpose of the mode degeneracy vector.

17. A system comprising an optical fiber transmission link for conveying a plurality of optical signals between a link input and a link output, the link including:
multimode optical fiber, wherein the multimode optical fiber supports a set of guided coupler modes and a set of cutoff coupler modes;
a plurality of the mode couplers, at least one of which mode couplers is optically coupled to the multimode fiber, wherein each mode coupler includes:
a long period Bragg grating characterized by a longitudinal refractive index profile and a transverse refractive index profile, wherein the transverse refractive index profile is obtained by free-form optimization to yield a set of desired spacings between a set of propagation constants of the set of guided coupler modes and the set of cutoff coupler modes, such that the longitudinal refractive index profile induces desired couplings between the guided coupler modes, while inhibiting undesired couplings between the guided coupler modes and the cutoff coupler modes, and undesired couplings between the guided coupler modes.

18. The system of claim 17 wherein the multimode fiber supports more than D=6 modes.

19. A method for designing a mode coupler, comprising:
providing a segment of a multimode waveguide capable of supporting a set of guided coupler modes and a set of cutoff coupler modes, and having an initial transverse refractive index profile and an initial longitudinal refractive index profile;
applying a free-form optimization to the transverse refractive index profile to obtain a set of desired spacings for a set of propagation constants for the set of guided coupler modes and the set of cutoff coupler modes; and
fabricating a grating consistent with the results of the free-form optimization.

20. The method of claim 19 wherein the multimode waveguide supports more than D=6 modes.
